(19) United States
(12) Patent Application Publication
(10) Pub. No.: US 2016/0224493 A1
(43) Pub. Date: Aug. 4, 2016

(54) UNIVERSAL SERIAL BUS (USB) KVM SWITCH USING VIRTUAL USB FOR SWITCHING AMONG MULTIPLE HOSTS

(71) Applicant: ASIX ELECTRONICS CORPORATION, Hsinchu (TW)

(72) Inventors: CHUAN CHIEH WANG, NEW TAIPEI (TW); BORBIN YAN, HSINCHU COUNTY (TW); YUNG CHUNG KAO, HSINCHU CITY (TW); JUI-FENG HSIEH, HSINCHU CITY (TW); CHENG YUAN LEE, HSINCHU CITY (TW)

(21) Appl. No.: 15/010,842

(22) Filed: Jan. 29, 2016

(30) Foreign Application Priority Data
Jan. 30, 2015 (TW) 104201487

(51) Int. Cl. G06F 13/38; G06F 13/42; G06F 13/40; G06F 13/22; G06F 13/24

(52) U.S. Cl. CPC G06F 13/385; G06F 13/22; G06F 13/24; G06F 13/4022; G06F 13/4068; G06F 13/4282

(57) ABSTRACT

A Universal Serial Bus (USB) keyboard-video-mouse (KVM) switch for connection between at least one host and at least one USB device is disclosed. The USB KVM switch includes a first virtual USB hub, a first virtual USB device, a microprocessor and a first multi-address USB device control module. The first virtual USB hub is configured to communicate with a first host. The first virtual USB device is configured to communicate with the first host via the first virtual USB hub, and is provided with endpoint setting data identical with that of a first USB device. The microprocessor is configured to generate the first virtual USB hub, and enumerate the first USB device in response to electrical connection of the first USB device to the USB KVM switch. The first multi-address USB device control module is configured to electrically couple with the first host via the first virtual USB hub, and to generate the first virtual USB device and determine the endpoint setting data of the first USB device in response to the enumeration of the first USB device.

### TECHNICAL FIELD

The present invention in general relates to a universal serial bus (USB) keyboard-video-mouse (KVM) switch and, in particular, to a USB KVM switch and method using a virtual USB for switching among multiple hosts.

### BACKGROUND

A keyboard-video-mouse (KVM) switch refers to an electronic device capable of using a set of console devices, including keyboard, video screen and mouse, to connect or control two or more computer hosts via a signal switching component or module. USB refers to a communication protocol for software and hardware modules between a computer host and its peripherals. Nowadays, USB has become one of the major standards for computers, smart phones and smart TVs. In addition, USB peripheral devices have been widely used by general computer hosts. A combination of USB technique and KVM switch results in a USB KVM switch specialized for use with USB devices.

Existing KVM switches are divided into three types: switching-type USB KVMs, emulating-type USB KVMs and reproducing-type USB KVMs, which will be discussed with reference to FIGS. 1A, 1B and 1C, respectively.

FIG. 1A is a block diagram of a switching-type USB KVM 10 in a communication system in prior art. Referring to FIG. 1A, the switching-type USB KVM 10 includes at least one USB signal switching module 11 and at least one USB hub 12. To switch among computer hosts PC1-PC4, a USB device D1 or D2 at the console side is disconnected from its originally connected computer host at the host side, and then switched to a new computer host. While the approach is simple, the new computer host is required to enumerate the USB device whenever the USB device is connected to the new computer host. Moreover, the USB device cannot work during the enumeration process and can only resume its normal operation after a waiting period. Besides, switching at a high speed may cause malfunction in the USB device. Consequently, it may be required to unplug and plug in the USB cord or reboot the computer host in order for normal operation.

FIG. 1B is a block diagram of an emulating-type USB KVM 20 in a communication system in prior art. Referring to FIG. 1B, the emulating-type USB KVM 20 includes a micro-processor (MCU) 21, a USB host controller 22, a USB hub 23 and a plurality of USB device controllers 24. This approach overcomes the defects in the switching-type USB KVM 10 in that when switching among the computer hosts PC1-PC4, USB device D1 or D2 is not disconnected from the computer hosts PC1-PC4, and data from the USB device D1 or D2 is sent by their corresponding USB device controller 24, thereby achieving a reliable switching operation. However, the USB devices at the console side are not directly connected to the computer hosts PC1-PC4. Instead, they are connected to the MCU 21 via the USB hub 23 and USB host controller 22. By executing a firmware program, MCU 21 emulates itself as a computer host that reads and parses data packets from the USB devices at the console side, converts the same into new data packets, and sends the new data packets to the computer hosts PC1-PC4. Therefore, a USB keyboard or USB mouse “seen” by the computer hosts PC1-PC4 is actually a new device emulated by the USB device controllers 24 rather than the USB keyboard D1 or USB mouse D2 at the console side. Such an approach may be liable to the following defects:

(1) drivers or application software for the keyboard and mouse provided by the manufacturers do not work;

(2) due to the limited resource in the MCU 21 of the USB KVM 20, it is often the case that the MCU 21 cannot parse the most updated versions of USB keyboard and mouse so that these USB devices are not available to the MCU 21, and thus the USB KVM 20 is not fully compatible; and

(3) the cost of the emulating-type USB KVM 20 is higher than that of the switching-type USB KVM 10.

FIG. 1C is a block diagram of a reproducing-type USB KVM 30 in a communication system in prior art. The reproducing-type USB KVM 30 operates in a similar fashion to the emulating-type USB KVM 20. Referring to FIG. 1C, the reproducing-type USB KVM 30 still includes an MCU 21, a USB host controller 22 and a USB hub 23 at the console side, while includes a USB hub 36 and at least two USB device controllers 34, 35 corresponding to each of the computer hosts PC1 and PC2 at the host side. One of the USB device controllers (i.e., USB device controller 34) is emulated as a USB keyboard, and the other of the USB device controllers (i.e., USB device controller 35) is emulated as a USB mouse. In particular, the emulated USB keyboard and USB mouse at the host side have the same, reproduced descriptors as the USB keyboard D1 and USB mouse D2 at the console side. As a result, the problems of device disconnection during switching and device incompatibility can be solved. However, to emulate any kinds of keyboard and mouse, each of the USB device controllers 34 and 35 should be a relatively advanced product. Moreover, each of the computer hosts PC1 and PC2 should be equipped with two such advanced USB device controllers. Consequently, the reproducing-type USB KVM 30 has the highest cost among the three types of USB KVMs.

The above-mentioned three types of USB KVMs can only support USB devices such as USB keyboards and USB mice, and may not support the increasingly popular touch devices such as touch-sensitive screens and digitizers.

### SUMMARY

The present disclosure provides a USB KVM switch that enables a USB device such as a USB keyboard or USB mouse to be available for two or more hosts. Moreover, by means of virtual switching, when the USB keyboard or USB mouse, having been enumerated, are switched among different hosts, no new enumeration is required. As a result, the USB keyboard or USB mouse are ready for use without performing a relatively time-consuming enumeration process. In addition, the USB keyboard and USB mouse are consistent with and have no difference from the physical USB keyboard and USB mouse. As a result, drivers provided by original manufacturers are still available for the USB KVM switch of the present disclosure..

Embodiments according to the present disclosure provide a universal serial bus (USB) keyboard-video-mouse (KVM) switch for connection between at least one host and at least one USB device. The USB KVM switch comprises a first virtual USB hub configured to communicate with a first host, a first virtual USB device configured to connect to the first USB host via the first virtual USB hub, and configured with an endpoint setting data identical with that of a first USB device, a microprocessor configured to generate the first virtual USB hub and, in response to an event that the first USB device is electrically connected, enumerate the first USB device via a USB host control module and a USB hub, and a first multi-address USB device control module configured to be electrically connected to the first host and be seen by the first USB host as the first virtual USB hub and, in response to an event that the first USB device is enumerated, determine the endpoint setting data of the first USB device.

Some embodiments according to the present disclosure provide a method of switching universal serial bus (USB) devices among multiple hosts. The method comprises generating a first virtual USB hub and a second virtual USB hub corresponding to a first host and a second host, respectively, enumerating a USB device and thereby obtaining the configuration descriptor of the USB device, obtaining endpoint setting data of the USB device by analyzing and parsing the configuration descriptor of the USB device, and based on the endpoint setting data of the USB device, generating a first virtual USB device corresponding to the first virtual USB hub and another first virtual USB device corresponding to the second virtual USB hub.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

Embodiments, or examples, of the disclosure illustrated in the drawings are now described using specific languages. It will nevertheless be understood that no limitation of the scope of the disclosure is thereby intended. Any alterations and modifications in the described embodiments, and any further applications of principles described in this document are contemplated as would normally occur to one of ordinary skill in the art to which the disclosure relates. Reference numbers may be repeated throughout the embodiments, but this does not necessarily require that feature(s) of one embodiment apply to another embodiment, even if they share the same reference number.

It will be understood that when an element is referred to as being “connected to” or “coupled to” another element, it may be directly connected to or coupled to the other element, or intervening elements may be present.

The objectives and advantages of the present invention are illustrated with the following description and upon reference to the accompanying drawings, in which:

FIG. 1A is a block diagram of a switching-type USB KVM in a communication system in prior art.

FIG. 1B is a block diagram of an emulating-type USB KVM in a communication system in prior art.

FIG. 1C is a block diagram of a reproducing-type USB KVM in a communication system in prior art.

FIG. 2 is a block diagram of a USB KVM switch in a KVM system, in accordance with some embodiments of the present invention.

FIG. 3 is a schematic flow diagram showing a control transfer (IN) type operation (host to receive data), in accordance with some embodiments of the present invention.

FIG. 4 is a schematic flow diagram showing a control transfer (OUT) type operation (host to send data), in accordance with some embodiments of the present invention.

FIG. 5A is a schematic flow diagram showing an interrupt transfer (IN) type operation (host to receive data), in accordance with an embodiment of the present invention.

FIG. 5B is a schematic flow diagram showing an interrupt transfer (IN) type operation (host to receive data), in accordance with another embodiment of the present invention.

FIG. 6A is a schematic flow diagram showing an interrupt transfer (OUT) type operation (host to send data), in accordance with an embodiment of the present invention.

FIG. 6B is a schematic flow diagram showing an interrupt transfer (OUT) type operation (host to send data), in accordance with another embodiment of the present invention.

FIG. 7 is a schematic flow diagram showing a bulk transfer (IN) type operation (host to receive data), in accordance with some embodiments of the present invention.

FIG. 8 is a schematic flow diagram showing a bulk transfer (OUT) type operation (host to send data), in accordance with some embodiments of the present invention.

FIG. 9A is a schematic flow diagram showing an isochronous transfer (OUT) type operation (host to send data), in accordance with some embodiments of the present invention.

FIG. 9B is a schematic diagram showing a method of frame alignment, in accordance with some embodiments of the present invention.

FIG. 10 is a schematic flow diagram showing an isochronous IN transfer type (IN) operation (host to receive data), in accordance with some embodiments of the present invention.

FIG. 11 is a block diagram of a USB KVM switch in a USB KVM system, in accordance with some embodiments of the present invention.

FIG. 12 is a diagram showing a method of sharing USB devices among hosts, in accordance with some embodiments of the present invention.

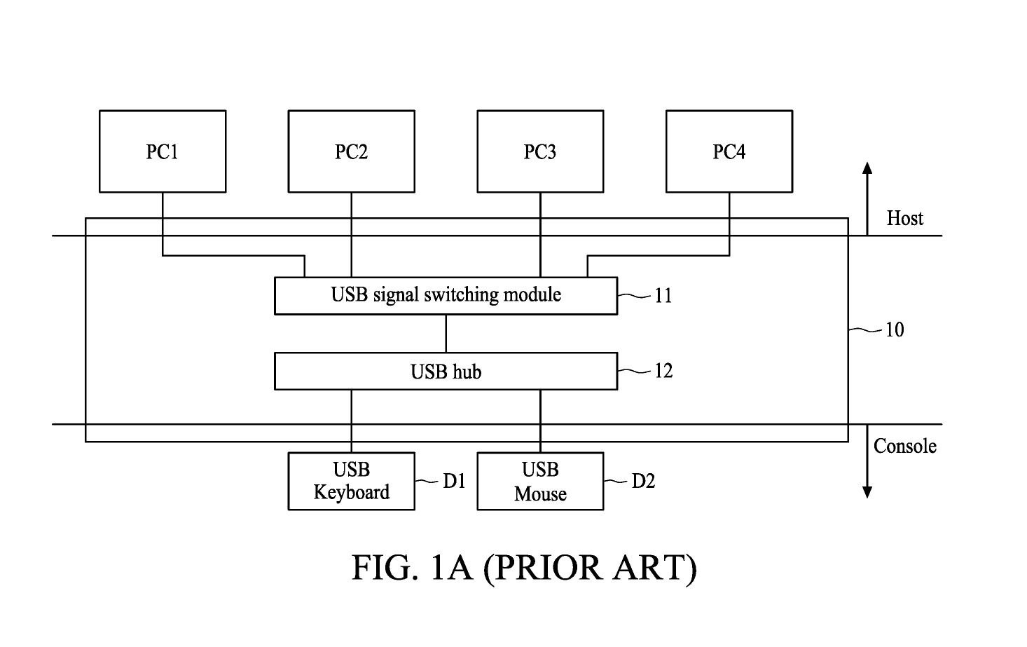

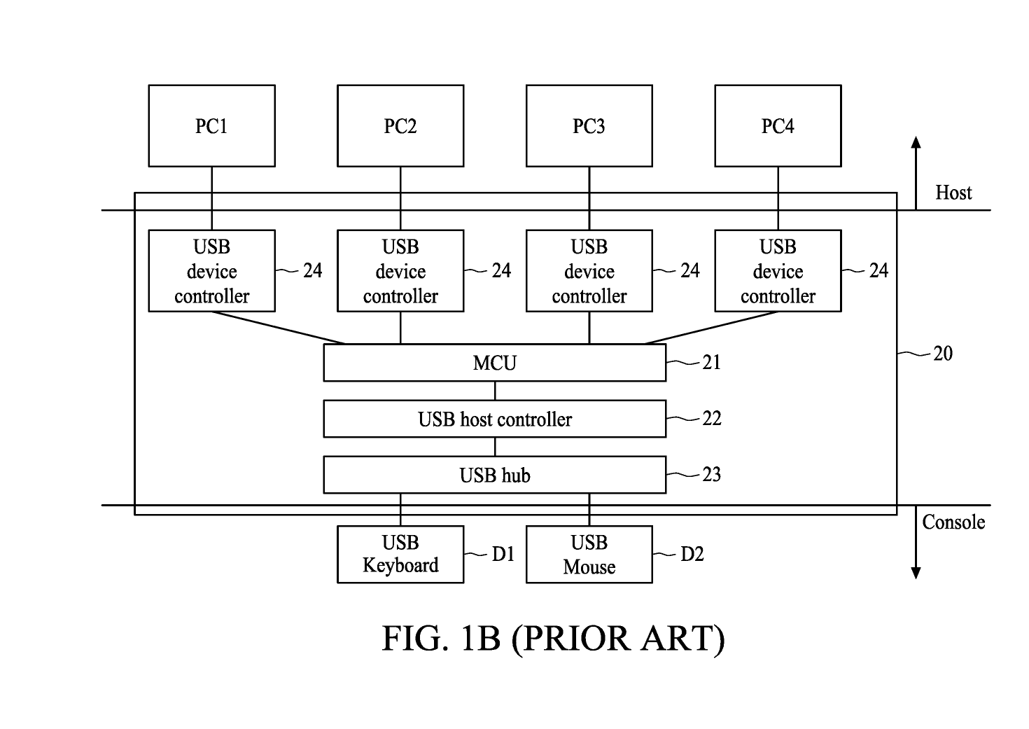

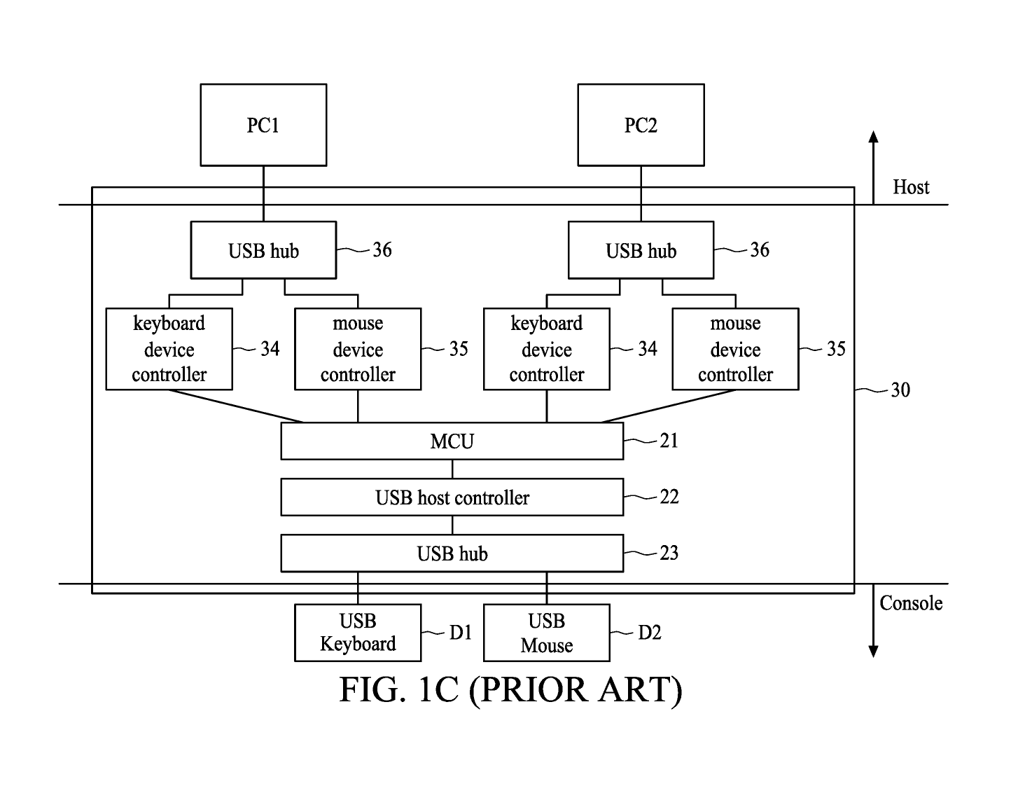

### DETAILED DESCRIPTION

The embodiments of the present invention are shown in the following description with the drawings, wherein similar or same components are indicated by similar reference numbers.

The USB specification specifies the way a USB peripheral device communicates with a USB host. Each USB peripheral device has a unique device address and multiple endpoint addresses. Communication between a host and an endpoint is made through a “pipe.” Once the pipe is established, the host can perform different types of transfers according to the characteristics of each endpoint. Therefore, USB communication in concept can be deemed as a virtual pipe. For example, an entire USB communication can consist of a large virtual pipe (i.e., USB bus) and up to 127 small virtual pipes. Each of the small virtual pipes can be deemed as a USB device. Further, each of the small virtual pipes consists of several micro virtual pipes, which are deemed as the endpoints. A single small virtual pipe may comprise 15 sets of micro virtual pipes (endpoints), and accordingly can address 15 input/output (or 30 in total) endpoints.

The concept of virtual pipes as mentioned above facilitates USB communication to be realized in a corresponding physical device endpoint buffer. In implementation, during transmission of a communication data packet, a token packet containing a header specifying the device address and endpoint address of a recipient is sent first, followed by a data packet containing a data payload, and then followed by a handshake packet to ensure successful transmission of the data. Accordingly, token, data and handshake are required for a standard USB transmission as specified. That is, a USB transaction consists of the above-mentioned token, data and handshake packets. In addition, four types of token packets, namely OUT, IN, SOF and SETUP, are defined in the USB specification. For a USB device, an OUT token packet sent thereto indicates that the USB device will receive data from a host, while an IN token packet indicates that the host will send data to the USB device. Moreover, an SOF (start of frame) token packet represents a signal for synchronization, while a SETUP token packet indicates that the host will send or receive data using endpoint 0. Of the above-mentioned four token packets, the OUT, IN and SETUP token packets, while not the SOF token packet, require a USB device to reply or process.

In addition, in the USB specification, USB devices are required to connect via a hub to a host, and the host is required to communicate via the hub with the USB devices attached under the hub.

When the host detects an event that a USB device is connected, the host enumerates the USB device to obtain information on the class, properties and attributes of the USB device and the data transfer type supported by the USB device. Currently for an endpoint there are four data transfer types: control transfer, bulk transfer, isochronous transfer and interrupt transfer. Enumeration refers to an operation for a USB host to obtain various descriptors of a USB device. These descriptors include a device descriptor, a configuration descriptor, an interface descriptor and an endpoint descriptor. By enumerating a USB device, a USB host performs data transfer with an endpoint of the USB device according to the data transfer type in the descriptors. The control transfer, bulk transfer, isochronous transfer and interrupt transfer have their respective standards. These transfers, except the isochronous transfer, require a data stage and a status stage, while the isochronous transfer requires the data stage and not the status stage. In the USB specification, if a USB device is not ready to process a request from a USB host in time, the USB device may send a NAK (negative acknowledgement) signal during the data stage or status stage. In that case, the USB host repeats transmitting an identical request at a regular interval. Data flow control for USB devices is performed in such a mechanism.

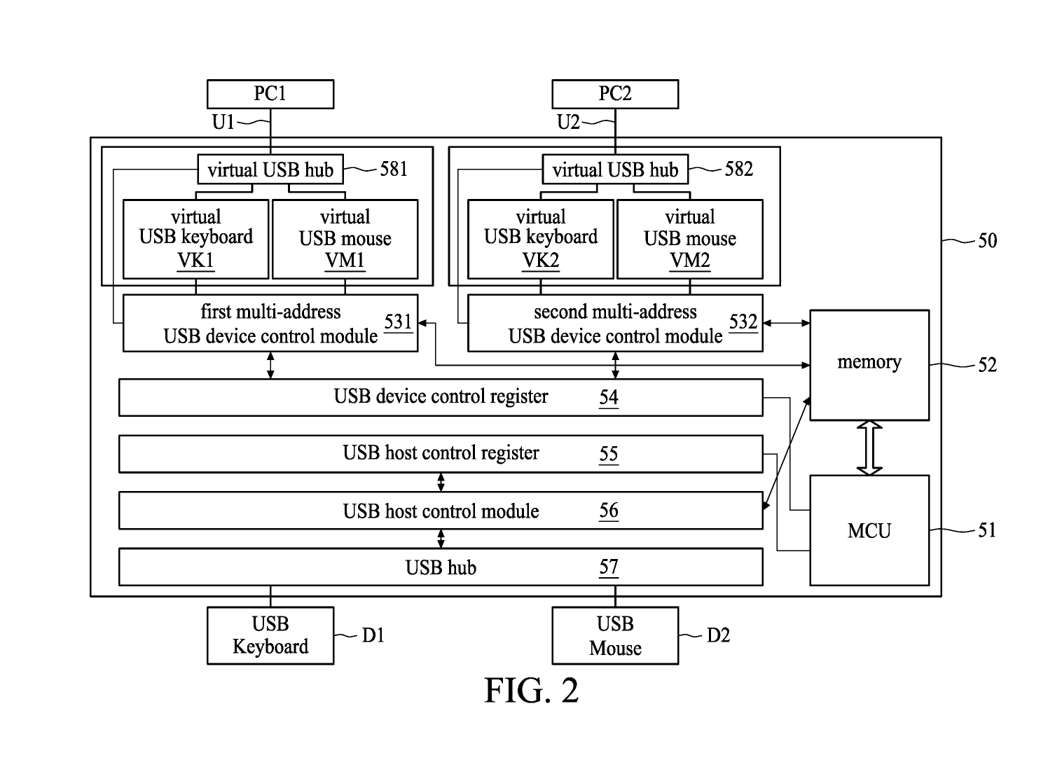

FIG. 2 is a block diagram of a USB KVM switch 50 in a KVM system, in accordance with some embodiments of the present invention. Referring to FIG. 2, the USB KVM switch 50 includes a microprocessor 51, a memory 52, a first multi-address USB device control module 531, a second multi-address USB device control module 532, a USB device control register 54, a USB host control register 55, a USB host control module 56 and a USB hub 57.

The microprocessor 51 controls the first multi-address USB device control module 531 and the second multi-address USB device control module 532 via the USB device control register 54, and controls the USB host control module 56 and the USB hub 57 via the USB host control register 55.

Each of the first multi-address USB device control module 531 and the second multi-address USB device control module 532 includes an independent USB physical layer (SIE/PHY) and a transceiver for converting, transmitting and parsing USB signals. Moreover, the USB device control register 54 includes an independent address manager and an endpoint manager. An endpoint buffer for the associated transmission and receiving is located in the memory 52. In an embodiment, the memory 52 includes a random access memory (RAM).

The USB host control module 56 also includes an independent USB physical layer (SIE/PHY) and a transceiver for converting, transmitting and parsing USB signals. Moreover, an endpoint buffer for the associated transmission and receiving is located in the memory 52.

When the KVM system is powered on, a firmware is loaded from an internal or external memory (such as a flash memory) to the microprocessor 51 in order to initialize the first multi-address USB device control module 531, the second multi-address USB device control module 532, the USB host control module 56 and the USB hub 57. Subsequently, the USB KVM switch 50 performs operations at the following five stages. At the first stage, a first virtual USB hub 581 and a second virtual USB hub 582 are generated. At the second stage, it is determined whether a USB peripheral device D1 or D2 is attached or connected to the USB KVM switch 50. At the third stage, the configuration of an attached USB peripheral device is analyzed. At the fourth stage, virtual USB devices VK1, VM1, VK2 and VM2 are generated and maintained. At the fifth stage, a bridge between a USB host and the attached USB peripheral device is established for data transfer. The above-mentioned five stages are discussed in detail below.

At the first stage, the address and endpoint setting data of the first virtual USB hub 581 and the second virtual USB hub 582 are written to memory spaces of the USB device control register 54 to which the first multi-address USB device control module 531 and the second multi-address USB device control module 532 correspond, respectively. As a result, two independent virtual USB hubs 581 and 582, under the control of the microprocessor 51, emulate USB hubs for their USB hosts PC1 and PC2, respectively. When the first USB host PC1 enumerates the first virtual USB hub 581 and the second USB host enumerates the second virtual USB hub 582, the microprocessor 51 responds appropriately for signal receiving and transmission during the enumeration processes. Afterwards, the USB hosts PC1 and PC2 communicate with USB devices in the KVM system via the first virtual USB hub 581 and the second virtual USB hub 582.

At the second stage, the microprocessor 51 plays the role of a USB host. Under the control of the microprocessor 51, the USB host control module 56 issues a command for detecting the connection status, either attachment or removal, of a USB device. When an event of connection, for example, the attachment of a USB device such as a USB mouse D2, is detected, the microprocessor 51 enumerates the USB mouse D2 according to a standard enumeration process, and assigns a physical device address to the USB mouse D2.

At the third stage, the USB host control module 56 analyzes and parses the configuration descriptor, obtained through the enumeration process, of the USB mouse D2 so as to acquire endpoint setting data, including endpoint number, endpoint address, endpoint transfer type (control, bulk, interrupt or isochronous) and endpoint packet size.

At the fourth stage, based on the data obtained at the third stage, the microprocessor 51 creates an endpoint setting identical with that of the acquired endpoint setting data in each of the first multi-address USB device control module 531 and the second multi-address USB device control module 532 via the USB device control register 54, and creates a virtual address for each of the created endpoints. Then, the first virtual USB hub 581 and the second virtual USB hub 582 report the connection event of the USB mouse D2.

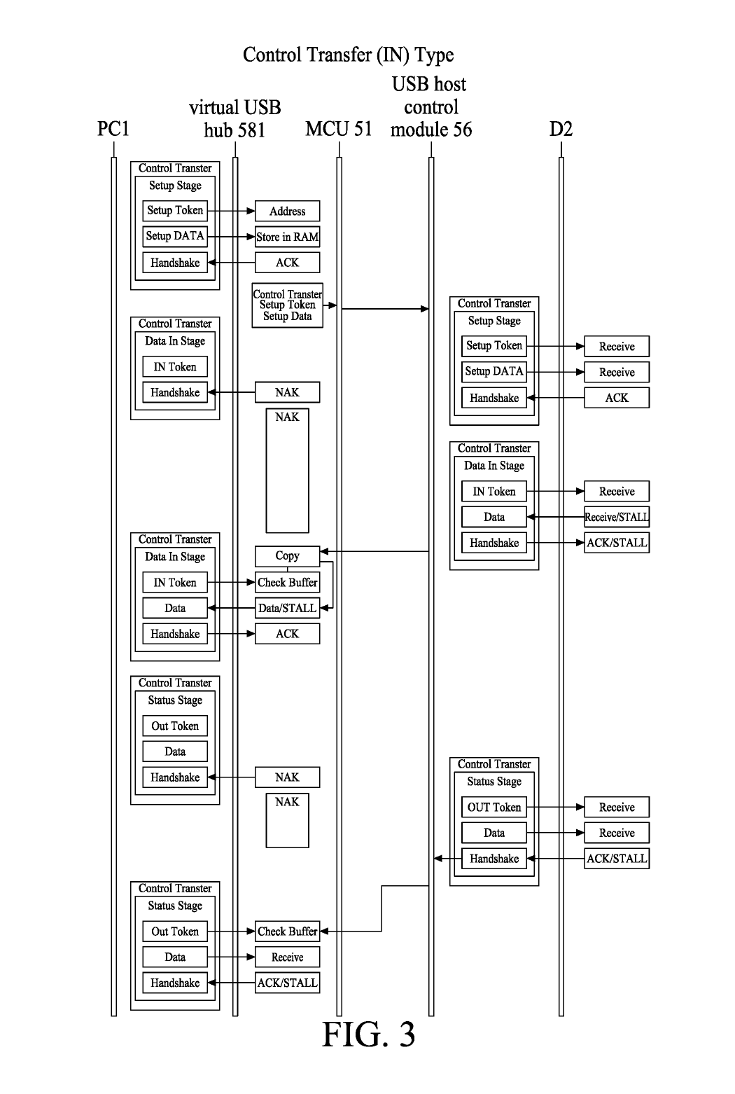

When the first host PC1 receives information on status change from the first virtual USB hub 581, the first host PC1 enumerates the USB mouse D2. Meanwhile, data transfer in the KVM system is performed according to the process flow illustrated in FIG. 3. Subsequently, the KVM system enters the fifth stage. The data transfer process in FIG. 3 will be discussed by way of the first host PC1 as an example.

In some embodiments, the USB KVM switch 50 includes a field-programmable gate array (FPGA) chip, an application-specific integrated circuit (ASIC) device, or a system-on-chip (SOC) device. Moreover, the hosts PC1 and PC2 include a computing device such as a personal computer (PC), laptop, notebook computer, personal digital assistant (PDA) or smartphone. Furthermore, USB devices include human-machine interface devices, USB storage devices, USB printers or other suitable USB electronic devices.

FIG. 3 is a schematic flow diagram showing a control transfer (IN) type operation (host to receive data), in accordance with some embodiments of the present invention. Referring to FIG. 3, at the Setup Stage of the control transfer, when the first host PC1 issues a request for Setup transaction to the first virtual USB hub 581, Setup token in the transaction is parsed by the first multi-address USB device control module 531, and data in the Setup token is compared by the address manager in the USB device control register 54 to determine whether there is a corresponding address. If affirmative, the data in the Setup token is then compared by the endpoint manager in the USB device control register 54 to determine whether there is a corresponding endpoint address. If affirmative, Setup data in the transaction is stored in the memory 52. In addition, an interrupt signal is issued and the process proceeds to the microprocessor 51. If a comparison between virtual address and physical address in a device address table by the first multi-address USB device control module 531 reveals that the USB device involved in the transaction is USB mouse D2 and the endpoint address is 0 (a default control endpoint), the microprocessor 51 sends the Setup data to the USB mouse D2 via the USB host control module 56 and the USB hub 57. Then the process proceeds to Data In Stage for receiving data from the USB mouse D2.

At the Data In Stage, the first host PC1 issues an IN token. The first multi-address USB device control module 531 replies to the first host PC1 with an NAK signal. The NAK signal is kept as a response to the first host PC1 during the Data In Stage until the USB host control module 56 successfully receives the data sent from the USB mouse D2 and sends the same to the first host PC1 before the first host PC1 issues a next IN token.

Next, the process proceeds to Status Stage. The first host PC1 sends an OUT token packet having a data length of 0. The first multi-address USB device control module 531 replies to the first host PC1 with an NAK signal until the USB host control module 56 performs, under the control of the microprocessor 51, an identical Status Stage with the USB mouse D2. Subsequently, the microprocessor 51 sends an ACK (acknowledgement) signal before the first host PC1 issues a next OUT token. Consequently, data transfer of the control transfer (IN) type is achieved.

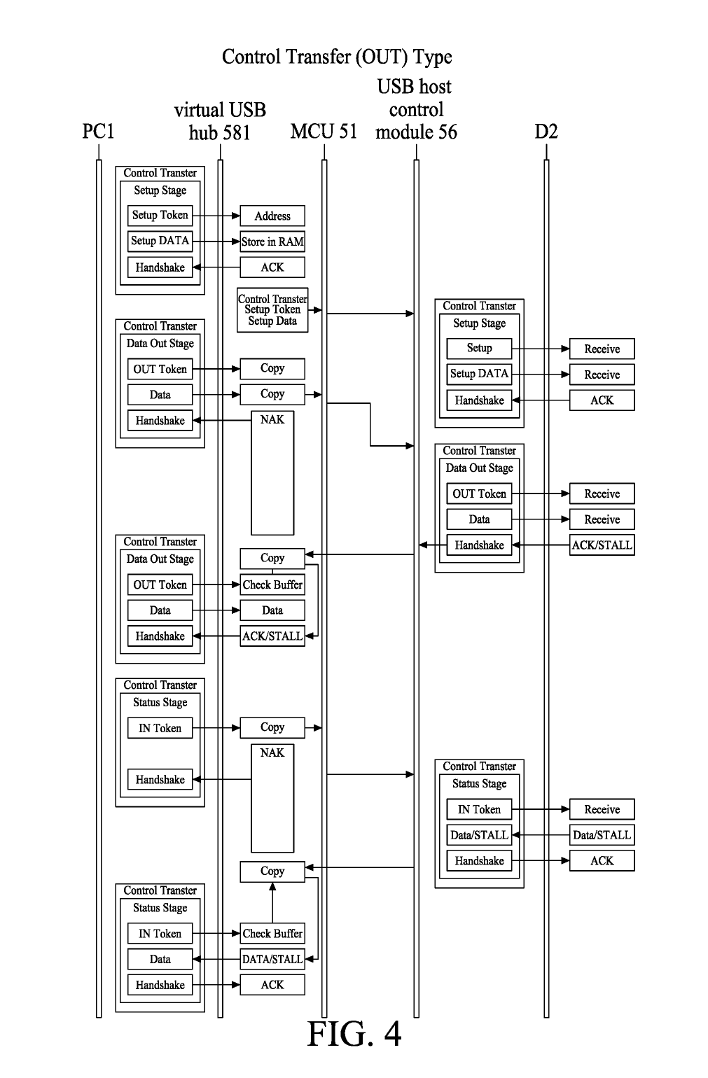

FIG. 4 is a schematic flow diagram showing a control transfer (OUT) type operation (host to send data), in accordance with some embodiments of the present invention. Referring to FIG. 4, at the Setup Stage of the control transfer, when the first host PC1 sends a Setup transaction to the first virtual USB hub 581, Setup token in the transaction is parsed by the first multi-address USB device control module 531, and data in the Setup token is compared by the address manager in the USB device control register 54 to determine whether there is a corresponding address. If affirmative, the data in the Setup token is then compared by the endpoint manager in the USB device control register 54 to determine whether there is a corresponding endpoint address. If affirmative, Setup data in the transaction is stored in the memory 52. In addition, an interrupt signal is issued and the process proceeds to the microprocessor 51. If a comparison between virtual address and physical address in a device address table by the first multi-address USB device control module 531 reveals that the USB device involved in the transaction is USB mouse D2 and the endpoint address is 0 (a default control endpoint), the microprocessor 51 sends the Setup data to the USB mouse D2 via the USB host control module 56 and the USB hub 57. Then the process proceeds to Data Out Stage for sending data to the USB mouse D2.

At the Data Out Stage, the first host PC1 issues an OUT token and an OUT data. The first multi-address USB device control module 531 replies to the first host PC1 with an NAK signal, and notifies the microprocessor 51 of the OUT token and OUT data. The microprocessor 51 sends the OUT token and OUT data to the USB mouse D2 via the USB host control module 56. The NAK signal is kept as a response to a handshake request from the first host PC1 with respect to the OUT token during the Data Out Stage until a reply from the USB mouse D2 is received. After an ACK reply from the USB mouse D2 is received, the ACK signal is sent in response to a next handshake request issued from the first host PC1 with respect to an OUT token.

Next, the process proceeds to Status Stage. The first host PC1 sends an IN token packet. The first multi-address USB device control module 531 replies to the first host PC1 with an NAK signal, and notifies the microprocessor 51 of the IN token. The microprocessor 51 sends the IN token to the USB mouse D2 via the USB host control module 56. An NAK signal is kept as a response to the IN token from the first host PC1 until a reply from the USB mouse D2 is received. After an IN data having a length of 0 as a reply from the USB mouse D2 is received, the IN data is sent to the first host PC1 in response to a next IN token issued from the first host PC1. Consequently, data transfer of the control transfer (OUT) type is achieved.

By performing the control transfer (IN) as illustrated in FIG. 3 and the control transfer (OUT) as illustrated in FIG. 4, the first host PC1 completes a proper enumeration for the USB mouse D2. As viewed from the first host PC1, a virtual USB mouse VM1 is present under the first virtual USB hub 581.

Similarly, by performing the control transfer (IN) as illustrated in FIG. 3 and the control transfer (OUT) as illustrated in FIG. 4, the first host PC1 completes a proper enumeration for a USB keyboard D1. As viewed from the first host PC1, a virtual USB keyboard VK1 is present under the first virtual USB hub 581.

Moreover, by performing the control transfer (IN) as illustrated in FIG. 3 and the control transfer (OUT) as illustrated in FIG. 4, the second host PC2 completes a proper enumeration for the USB mouse D2. As viewed from the second host PC2, a virtual USB mouse VM2 is present under the second virtual USB hub 582.

Similarly, by performing the control transfer (IN) as illustrated in FIG. 3 and the control transfer (OUT) as illustrated in FIG. 4, the second host PC2 completes a proper enumeration for the USB keyboard D1. As viewed from the second host PC2, a virtual USB keyboard VK2 is present under the second virtual USB hub 582.

Conflict may occur when the first host PC1 and the second host PC2 simultaneously enumerate a USB peripheral device because in that case the endpoint setting data of USB peripheral device is simultaneously configured in the memory spaces of the USB device control register 54 to which the first multi-address USB device control module 531 and the second multi-address USB device control module 532 correspond. To avoid any such conflict, a data arbitration mechanism is configured by the microprocessor 51 to, according to a first-in-first-serve rule for example, allow a host that first enters the Setup Stage to obtain the priority of data transfer. The microprocessor 51 keeps responding NAK to another host for the control of data flow when the other host enters Data Stage or Status Stage. When the host having the priority of data transfer enters Status Stage, the other host that awaits the data transfer resumes to a normal operation of data transfer.

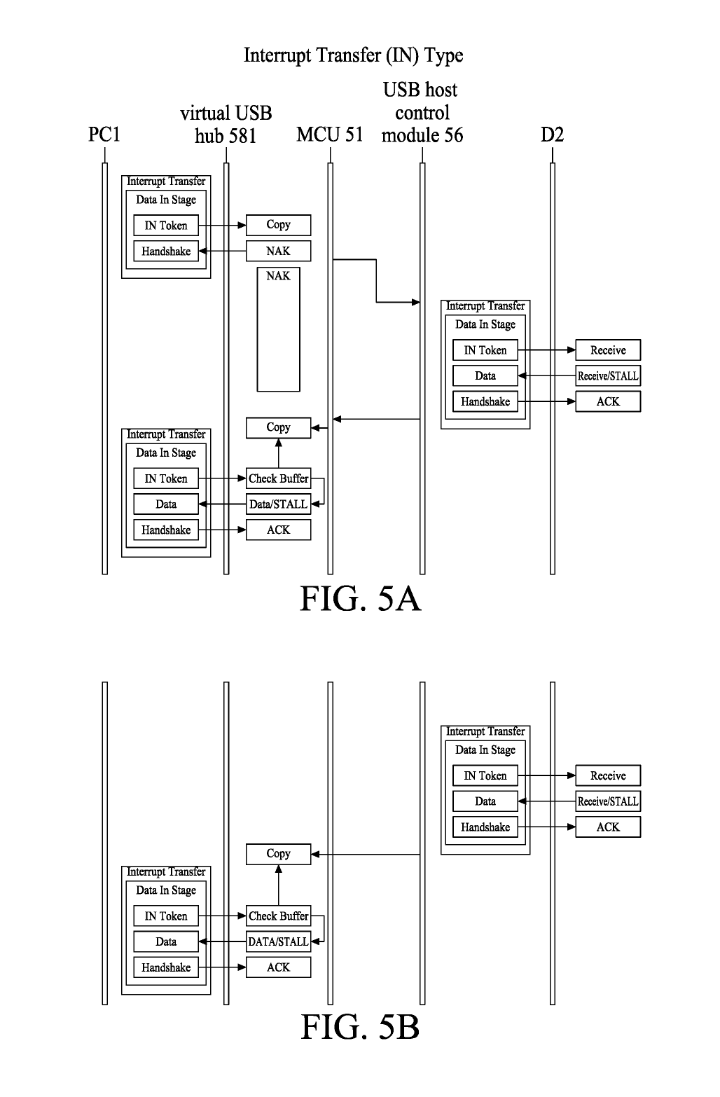

FIG. 5A is a schematic flow diagram showing an interrupt transfer (IN) type operation (host to receive data), in accordance with an embodiment of the present invention. The main USB peripheral devices at the console side of the USB KVM switch 50 include the USB mouse D2 and USB keyboard D1. For these USB peripheral devices, transfer of data packets is achieved through the interrupt transfer. Referring to FIG. 5A, when the first host PC1 issues a request for interrupt transfer (IN) to the virtual USB mouse VM1, the first multi-address USB device control module 531 replies with an NAK signal in response to an IN token. Moreover, the IN token is parsed by the first multi-address USB device control module 531, stored in the memory 52, and processed by the microprocessor 51. By comparing the virtual address and physical address in the device address table by the first multi-address USB device control module 531, the USB mouse D2 and the endpoint address 1 are identified. Next, the microprocessor 51 sends the interrupt transfer data to the USB mouse D2 via the USB host control module 56 and the USB hub 57. In response to a reply from the USB mouse D2, the USB host control module 56 proactively sends an ACK signal to the USB mouse D2 to finish the interrupt transfer between to the USB host control module 56 and the USB mouse D2. Data received from the USB mouse D2 is stored in an endpoint buffer corresponding to the virtual USB mouse VM1, and subsequently sent to the first host PC1 when the first host PC1 issues a next request for interrupt transfer (IN) to the virtual USB mouse VM1. Accordingly, the interrupt transfer (IN) between the virtual USB mouse VM1 and the first host PC1 is achieved.

Likewise, the interrupt transfer (IN) between the virtual USB keyboard VK1 and the first host PC1 can also be achieved.

The above embodiment of interrupt transfer (IN) is discussed by taking the first host PC1 as an example of a dominating computer. In that case, for any request issued from the non-dominating second host PC2 to the virtual mouse VM2 for an interrupt transfer (IN), the microprocessor 51 replies with an NAK signal. When the dominating computer is switched from the first host PC1 to the second host PC2, a request for interrupt transfer (IN) issued from the second host PC2 to the virtual USB mouse VM2 is processed according to the same fashion as that between the first host PC1 and the virtual USB mouse VM1. In that case, for any request issued from the non-dominating first host PC1 to the virtual mouse VM1 for an interrupt transfer (IN), the microprocessor 51 replies with an NAK signal.

While in the above embodiment data transfer of the interrupt transfer (IN) type among the first host PC1, the second host PC2 and the USB mouse D2, the USB keyboard D1 is addressed, delay may occur in such data transfer. Specifically, a host sets an interval time for polling an endpoint in a transaction of interrupt transfer (IN), and will issue a request for interrupt transfer (IN) to the endpoint at every polling interval. If the USB device replies with an NAK signal, the host does not issue such a request until next polling interval time. As a result, the data packet received from the USB device during the interrupt transfer (IN) is subject to delay up to two polling intervals. Such delay may cause lagging in the cursor operation of a USB mouse. To address the issue, a method illustrated in FIG. 5B is proposed.

FIG. 5B is a schematic flow diagram showing an interrupt transfer (IN) type operation (host to receive data), in accordance with another embodiment of the present invention. Referring to FIG. 5B, since the configuration descriptor of the USB mouse D2 is parsed in enumeration, the polling interval for the endpoint of the USB mouse D2 in an interrupt transfer (IN) is obtained. Accordingly, the microprocessor 51 and the USB host control module 56 can proactively issue a request for interrupt transfer to the USB mouse D2 at each polling interval. When the USB mouse D2 replies with data, the data is stored in an output zone of the endpoint buffer corresponding to the virtual USB mouse VM1, and sent to the first host PC1 when the first host PC1 issues a next request for interrupt transfer (IN) to the virtual USB mouse VM1. As a result, the delay can be controlled within 0 polling interval. Effectively, no lagging may occur in the cursor operation of the USB mouse D2. Such a method is also applicable to the USB keyboard D1 for data transfer of the interrupt transfer (IN) type.

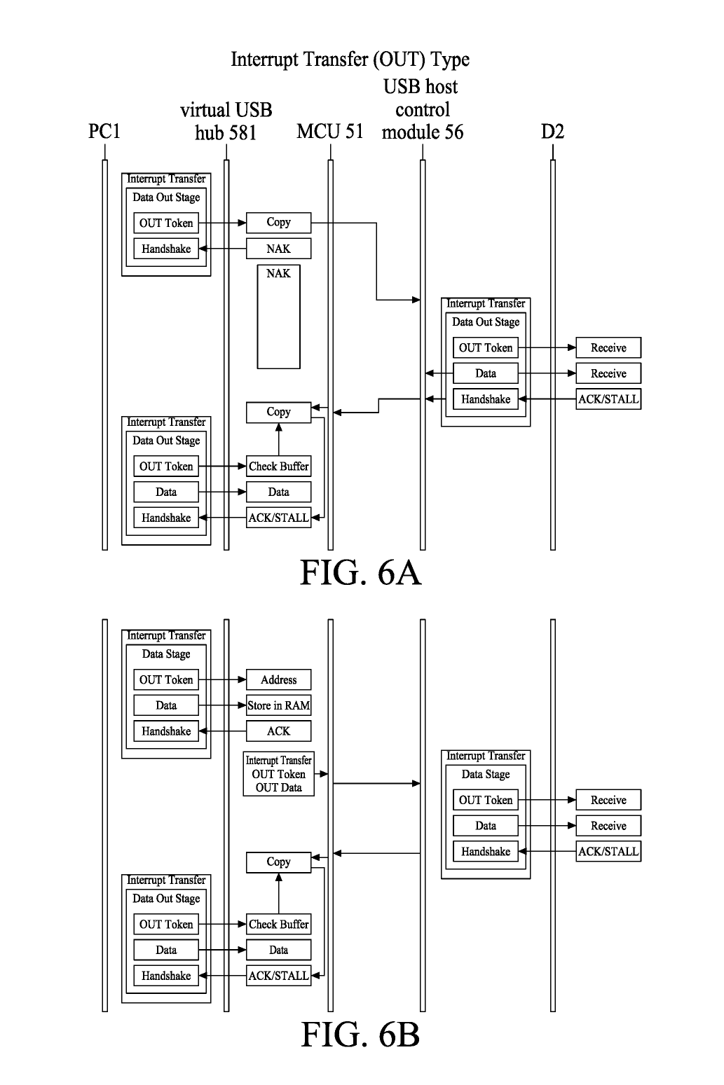

FIG. 6A is a schematic flow diagram showing an interrupt transfer (OUT) type operation (host to send data), in accordance with an embodiment of the present invention. Referring to FIG. 6A, when the first host PC1 issues a request for interrupt transfer (OUT) to the virtual USB mouse VM1, the first multi-address USB device control module 531 replies with an NAK signal in response to an OUT token. Moreover, the OUT token and data packets are parsed by the first multi-address USB device control module 531, stored in the memory 52, and processed by the microprocessor 51. By comparing the virtual address and physical address in the device address table by the first multi-address USB device control module 531, the USB mouse D2 and the endpoint address 2 are identified. Next, the microprocessor 51 sends the data to the USB mouse D2 via the USB host control module 56 and the USB hub 57. In response to an ACK reply from the USB mouse D2, the microprocessor 51 stores the ACK reply to the endpoint buffer corresponding to the virtual USB mouse VM1, and subsequently sends the ACK reply to the first host PC1 when the first host PC1 issues a next request for interrupt transfer (OUT) to the virtual USB mouse VM1 to finish the interrupt transfer (OUT) between the first host PC1 and the virtual USB mouse VM1.

Likewise, the interrupt transfer (OUT) between the virtual USB keyboard VK1 and the first host PC1 can also be achieved.

The above embodiment of interrupt transfer (OUT) is discussed by taking the first host PC1 as an example of a dominating computer. In that case, for any request issued from the non-dominating second host PC2 to the virtual mouse VM2 for an interrupt transfer (OUT), the microprocessor 51 replies with an NAK signal. When the dominating computer is switched from the first host PC1 to the second host PC2, a request for interrupt transfer (OUT) issued from the second host PC2 to the virtual USB mouse VM2 is processed according to the same fashion as that between the first host PC1 and the virtual USB mouse VM1. In that case, for any request issued from the non-dominating first host PC1 to the virtual mouse VM1 for an interrupt transfer (OUT), the microprocessor 51 replies with an NAK signal.

While in the above embodiment data transfer of the interrupt transfer (OUT) type among the first host PC1, the second host PC2 and the USB mouse D2, the USB keyboard D1 is addressed, delay may occur in such data transfer. Specifically, a host sets an interval time for polling an endpoint in a transaction of interrupt transfer (OUT), and will issue a request for interrupt transfer (OUT) to the endpoint at every polling interval. If the USB device replies with an NAK signal, the host does not issue such a request until next polling interval time. As a result, the data packet received from the USB device during the interrupt transfer (OUT) is subject to delay up to two polling intervals. To address the issue, a method illustrated in FIG. 6B is proposed.

FIG. 6B is a schematic flow diagram showing an interrupt transfer (OUT) type operation (host to send data), in accordance with another embodiment of the present invention. Referring to FIG. 6B, since the configuration descriptor of the USB mouse D2 is parsed in enumeration, the polling interval for the endpoint of the USB mouse D2 in an interrupt transfer (OUT) is obtained. Accordingly, when the endpoint of the virtual USB mouse VM1 receives the request for interrupt transfer (OUT) from the first host PC1, the microprocessor 51 replies with an ACK signal to finish the interrupt transfer (OUT) between the first host PC1 and the virtual USB mouse VM1. Subsequently, the microprocessor 51 immediately sends the same data of interrupt transaction via the USB host control module 56 for issuing a request for interrupt transfer (OUT) to the USB mouse D2. As a result, the delay can be controlled within 0 polling interval. Such a method is also applicable to the USB keyboard D1 for data transfer of the interrupt transfer (OUT) type.

The above embodiments of interrupt transfer (IN) and interrupt transfer (OUT) are discussed by taking a USB mouse and a USB keyboard as an example. These USB devices belong to the class of human interface device (HID). Most of USB devices of the HID class only provide endpoints for control and for the interrupt transfer (IN), which may be used in the KVM system described and illustrated with reference to FIG. 2. In contrast, by way of a virtual USB mechanism, the present disclosure enables the first host PC1 and second host PC2 to share the USB mouse D2 and USB keyboard D1 in a KVM system. In addition, once the virtual USB mouse VM1 and virtual USB keyboard VK1 associated with the first host PC1 and the virtual USB mouse VM2 and virtual USB keyboard VK2 associated with the second host PC2 are established, when the first host PC1 is switched to the second host PC2 and vice versa, no new enumeration either of the USB mouse D2 or USB keyboard D1 is required for the dominating host. As a result, the present disclosure enables multiple hosts to share the resources of multiple USB devices, and effectively achieves switching among the hosts and USB devices in a multi-host, multi-device KVM system.

In the present disclosure, the virtual USB mechanism enables a delayed response of a physical USB device to a host. Moreover, the virtual USB mechanism supports the virtualization of USB devices such as USB mouse D2 and USB keyboard D1, and also supports, by means of firmware design, the virtualization of USB storage devices, USB audio devices and USB hubs, which are the most common USB devices, and other USB peripheral devices as well. The transfer types for the USB storage device, USB audio device and USB hub are bulk transfer, isochronous transfer and interrupt transfer, respectively. In an embodiment, the microprocessor 51 is configured to properly enumerate a USB audio device and a USB storage device for the first host PC1 and the second host PC2 by performing the control transfer (IN) process in FIG. 3 and the control transfer (OUT) process in FIG. 4. After enumeration, as viewed from the first host PC1, for example, a virtual USB audio device and a virtual USB storage device are present under the first virtual USB hub 581.

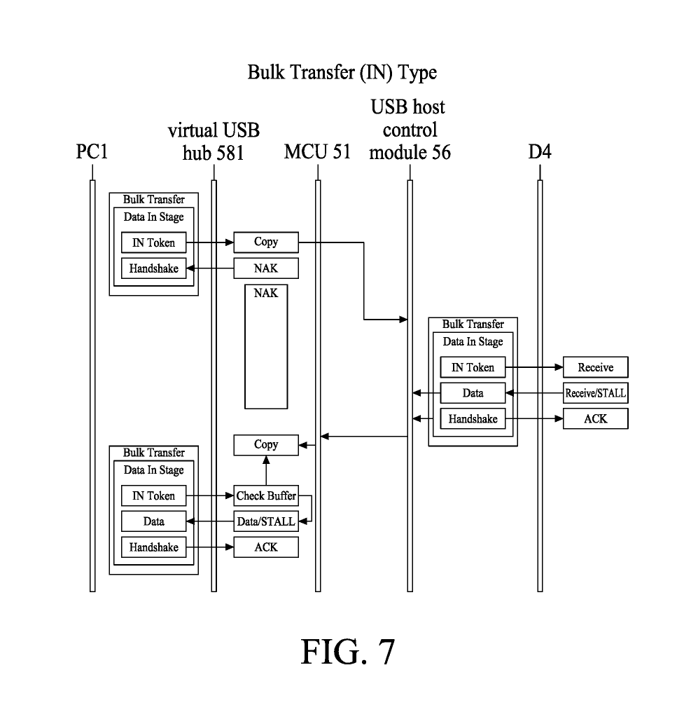

FIG. 7 is a schematic flow diagram showing a bulk transfer (IN) type operation (host to receive data), in accordance with some embodiments of the present invention. Referring to FIG. 7, when the first host PC1 issues a request for bulk transfer (IN), the IN token is parsed by the first multi-address USB device control module 531 and stored in the memory 52. Moreover, the first multi-address USB device control module 531 replies with an NAK signal to the first host PC1. The process then proceeds to the microprocessor 51. By comparing the virtual address and physical address in the device address table by the first multi-address USB device control module 531, a USB storage device D4 and an endpoint address 1 are identified. Next, the microprocessor 51 sends the bulk transfer data to the USB storage device D4 via the USB host control module 56 and the USB hub 57. The first multi-address USB device control module 531 keeps replying with a NAK signal in response to a request issued from the first host PC1 to the USB storage device D4 for bulk transfer (IN) until data from the USB storage device D4 is received. The data from the USB storage device D4 is sent to the first host PC1 when the first host PC1 issues a next IN token.

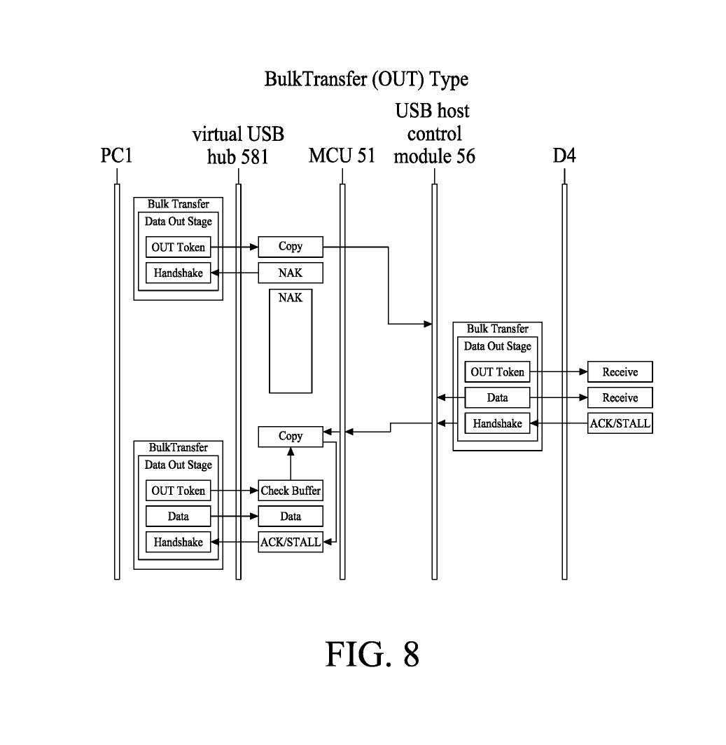

FIG. 8 is a schematic flow diagram showing a bulk transfer (OUT) type operation (host to send data), in accordance with some embodiments of the present invention. Referring to FIG. 8, when the first host PC1 issues a request for bulk transfer (OUT), the OUT token and data are parsed by the first multi-address USB device control module 531 and stored in the memory 52. Moreover, the first multi-address USB device control module 531 replies with an NAK signal to the first host PC1, and notifies the microprocessor 51 to process the bulk transfer. By comparing the virtual address and physical address in the device address table by the first multi-address USB device control module 531, the USB storage device D4 and an endpoint address 1 are identified. Next, the microprocessor 51 sends the data to the USB storage device D4 via the USB host control module 56 and the USB hub 57. When an ACK reply from the USB storage device D4 is received, the microprocessor 51 sends the ACK reply to the first host PC1 when the first host PC1 issues a next OUT token and data.

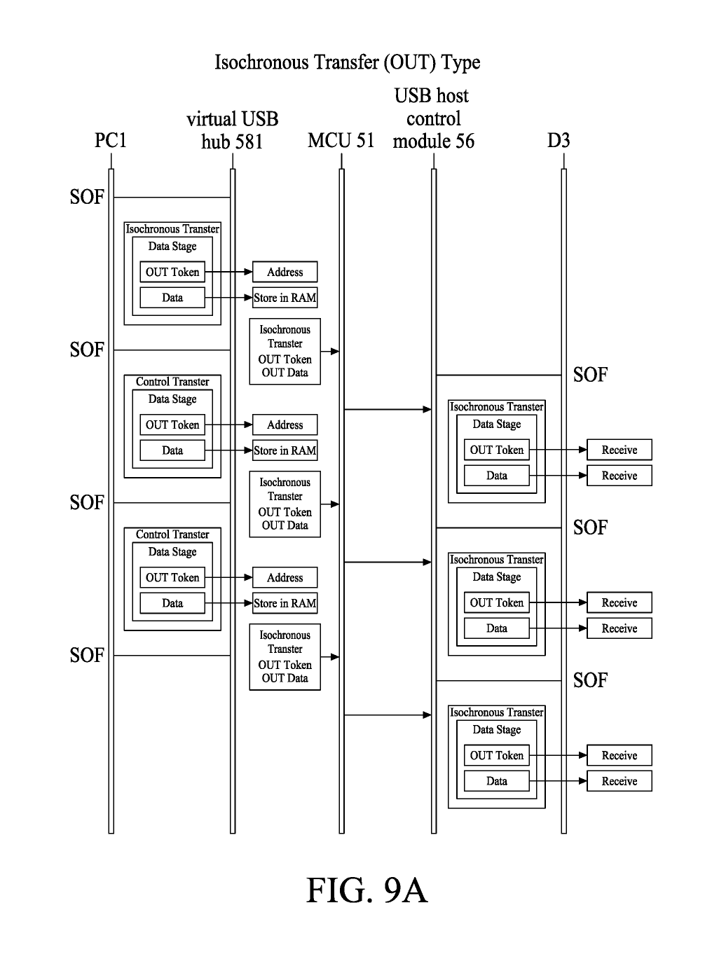

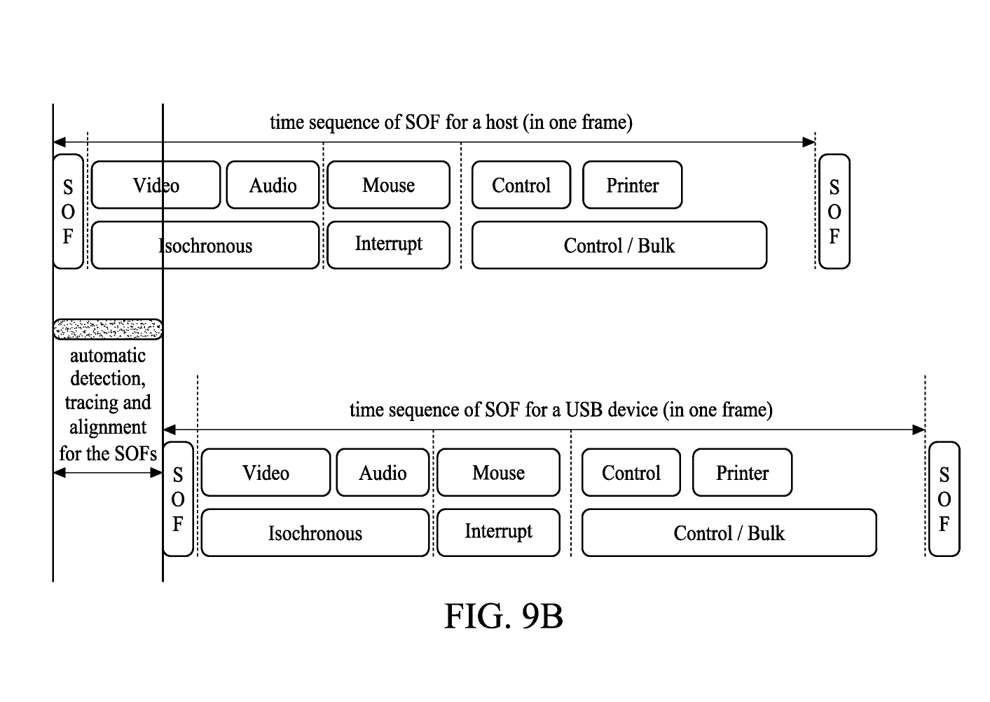

FIG. 9A is a schematic flow diagram showing an isochronous transfer (OUT) type operation (host to send data), in accordance with some embodiments of the present invention. A main difference between the isochronous transfer and other types of transfers resides in that only token and data, but not handshake, are involved in an isochronous transfer.

Referring to FIG. 9A, when the first host PC1 issues a request for bulk transfer (OUT), the OUT token and data are parsed by the first multi-address USB device control module 531 and stored in the memory 52, and notifies the microprocessor 51 to process the bulk transfer (OUT). By comparing the virtual address and physical address in the device address table by the first multi-address USB device control module 531, an USB audio device D3 and an endpoint address 2 are identified. Next, the microprocessor 51 sends the data to the USB audio device D3 via the USB host control module 56 and the USB hub 57.

The data transfer illustrated in FIG. 9A may cause delay in the output of the USB audio device D3, which may exceed over a standard SOF (start of frame). Such delay may result in discontinuous sound or acoustic burst. To address the issue, a method illustrated in FIG. 9B is proposed.

FIG. 9B is a schematic diagram showing a method of frame alignment, in accordance with some embodiments of the present invention. Referring to FIG. 9B, the problem of time delay in the output of a USB audio device may be alleviated by synchronizing the SOF output of the USB host control module 56 with that of the first host PC1. In an embodiment according to the present disclosure, the microprocessor 51 is configured to synchronize the SOF output of the USB host control module 56 with that of the first host PC1 so that the SOF output of the USB audio device is synchronized with that of the first host PC1.

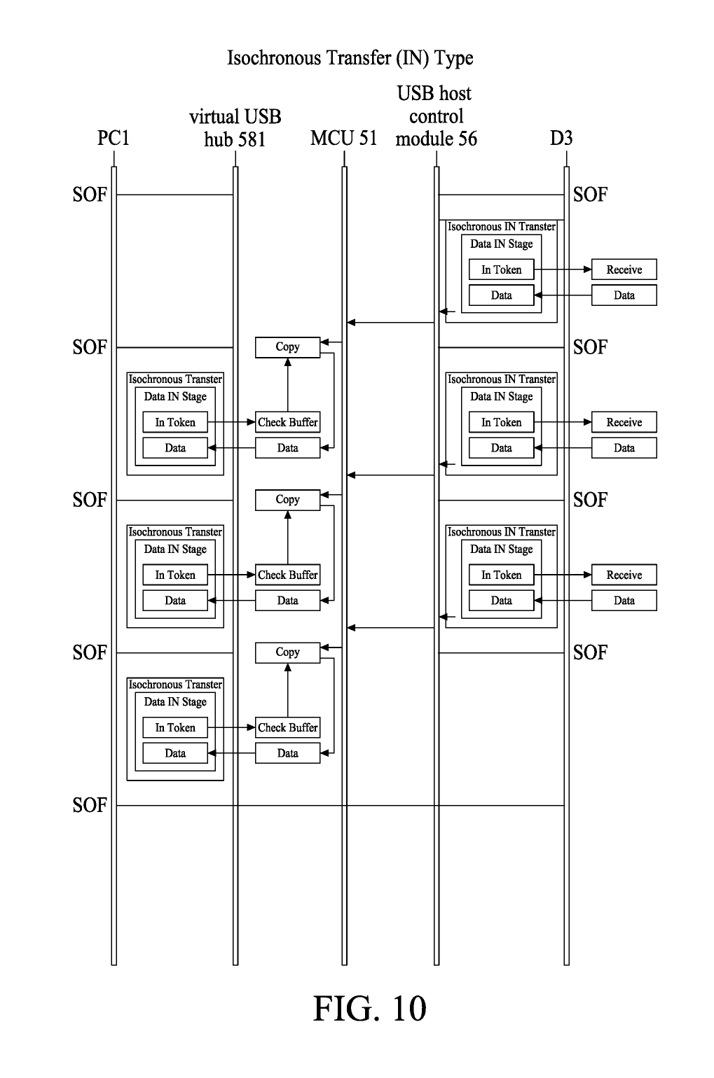

FIG. 10 is a schematic flow diagram showing an isochronous transfer (IN) type operation (host to receive data), in accordance with some embodiments of the present invention. Referring to FIG. 10, as the first host PC1 issues a request for isochronous transfer (IN), the virtual USB audio device is required to output audio data. Therefore, before the first host PC1 issues a request for isochronous transfer (IN), the microprocessor 51 analyzes the endpoint descriptor of the USB audio device for isochronous transfer (IN) to obtain information on polling interval, and thereby set the USB host control module 56 so that the USB host control module 56 proactively polls the USB audio device for the data of isochronous transfer (IN) at the same polling interval as the first host PC1. Accordingly, when the first host PC1 issues a request for isochronous transfer (IN), the USB host control module 56 proactively sends the data to the first host PC1 as a response.

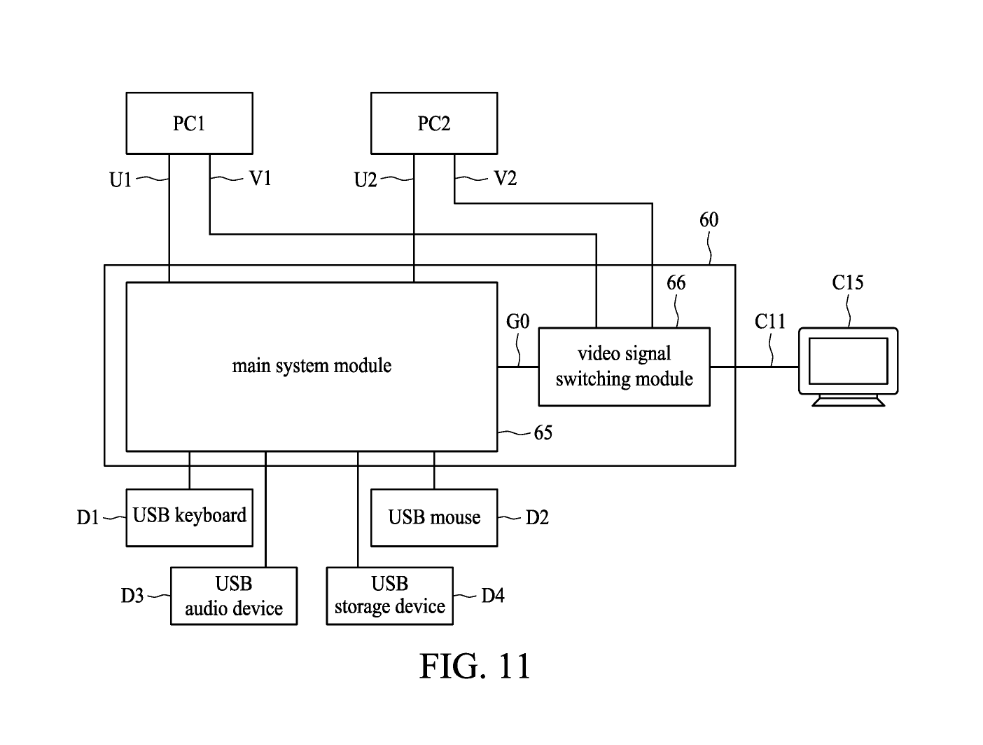

FIG. 11 is a block diagram of a USB KVM switch in a USB KVM system 60, in accordance with some embodiments of the present invention. Referring to FIG. 11, the USB KVM system 60 includes a main system module 65 and a video signal switching module 66. The main system module 65 is similar to the USB KVM switch 50 described and illustrated with reference to FIG. 2 except that, for example, the main system module 65 may be coupled to a USB audio device D3 and a USB storage device D4 as well as the USB keyboard D1 and USB mouse D2. In addition, the main system module 65 further includes a virtual USB audio device and a virtual USB storage device as well as the virtual USB keyboard and the virtual USB mouse.

The main system module 65 is coupled to USB ports of the first host PC1 and the second host PC2 through USB cables U1 and U2, respectively. The video signal switching module 66 is coupled to output ports of video graphics array (VGA) cards of the first host PC1 and the second host PC2 through video cables V1 and V2, respectively. Also, the video signal switching module 66 communicates with the main system module 65 by means of control signal GO. The main system module 65 switches the USB keyboard D1, USB mouse D2, USB audio device D3 and USB storage device D4 between the first host PC1 and the second host PC2. During a switching operation, the main system module 65 issues to the image signal switching module 66 a control signal GO containing a request for switching, and outputs video signal to a display C15 via a video cable C11.

In an embodiment, the video signal switching module 66 may take the form of an integrated circuit (IC), the type of which may be different as the types of video signals are different, for switching, for example, analog VGA, digital visual interface (DVI), high-definition multimedia interface (HDMI) and DisplayPort (DP) signals.

In the embodiments as above mentioned, the virtual USB mechanism supports not only the USB keyboard D1 and the USB mouse D2 at the console side but also the USB audio device D3, USB storage device D4 and USB hub to be switchable between the first host PC1 and the second host PC2. In addition, at the host side, no physical USB hubs are needed because the multi-address USB device control modules are configured to perform in a virtual manner as USB hubs. As a result, the number of active USB components is significantly reduced.

In some embodiments, the USB KVM switch 60 includes a field-programmable gate array (FPGA) chip, an application-specific integrated circuit (ASIC) device, or a system-on-chip (SOC) device.

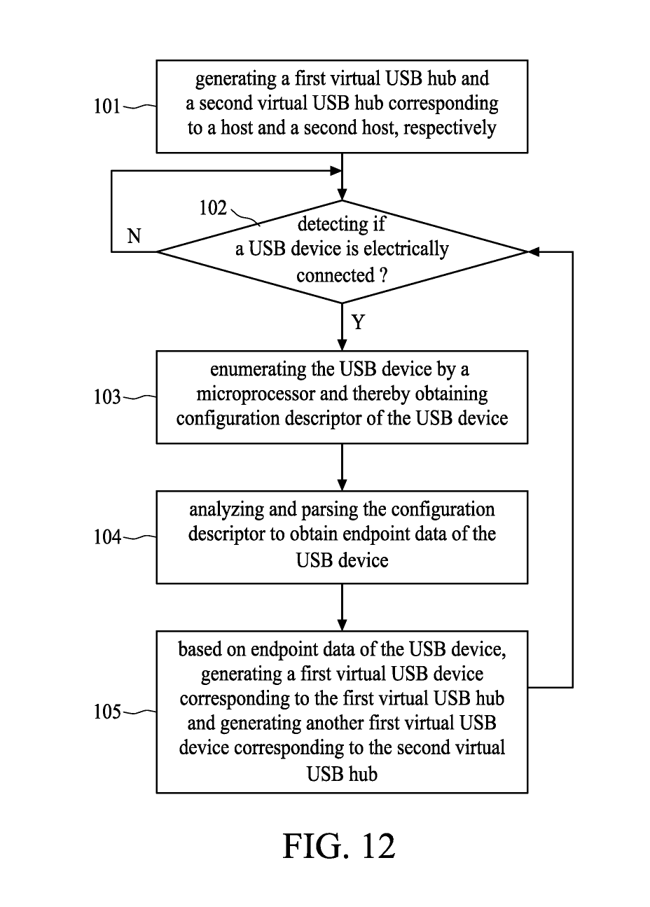

FIG. 12 is a diagram showing a method of sharing USB devices among hosts, in accordance with some embodiments of the present invention. Referring to FIG. 12, in operation 101, a first virtual USB hub and a second virtual USB hub corresponding to a first host and a second host, respectively, are generated in a USB KVM switch.

In operation 102, it is detected whether a USB device is electrically connected to the USB KVM switch. If not, the detection operation 102 is repeated.

If in operation 102 the attachment of a USB device is detected, then in operation 103 a microprocessor enumerates the USB device and thereby obtains the configuration descriptor of the USB device.

Next, in operation 104, endpoint setting data of the USB device is obtained by analyzing and parsing the configuration descriptor of the USB device.

In operation 105, based on the endpoint setting data of the USB device, a first virtual USB device corresponding to the first virtual USB hub and another virtual USB device corresponding to the second virtual USB hub are generated in the USB KVM switch.

Subsequently, the operation 102 is repeated to detect if another USB device is electrically connected to the USB KVM switch. If affirmative, operations 103 to 105 are repeated. Moreover, in operation 105, based on the endpoint setting data of the newly attached USB device, a second virtual USB device corresponding to the first virtual USB hub and another second virtual USB device corresponding to the second virtual USB hub are generated in the USB KVM switch.

In an embodiment, the endpoint setting data includes information on a polling interval for an endpoint in an interrupt transfer (IN). Moreover, in an interrupt transfer (IN) during which a first host receives data from an endpoint of a USB device, a request for interrupt transfer (IN) is proactively issued to the endpoint of the USB device before the first host issues a request for interrupt transfer (IN) to the endpoint. When the USB device replies with data in the interrupt transfer (IN), the data is stored in an output zone of an endpoint buffer corresponding to a virtual USB device, and then sent to the first host when the first host issues the request for interrupt transfer (IN) to the endpoint.

In another embodiment, the endpoint setting data includes information on a polling interval for an endpoint in an interrupt transfer (OUT). Moreover, in an interrupt transfer (OUT) during which a first host sends data to an endpoint of a USB device, an ACK signal is replied to the first host when a virtual USB device receives a request for interrupt transfer (OUT) issued from the first host to the endpoint. Then the request for interrupt transfer (OUT) is immediately sent to the endpoint of the USB device.

In still another embodiment, the endpoint setting data includes information on a polling interval for an endpoint in an isochronous transfer (OUT). Moreover, in an isochronous transfer (OUT) during which a first host sends data to an endpoint of a USB device, the SOF of the USB device is synchronized with that of the first host.

In yet another embodiment, the endpoint setting data includes information on a polling interval for an endpoint in an isochronous transfer (IN). Moreover, in an isochronous transfer (IN) during which a first host receives data from an endpoint of a USB device, a request for isochronous transfer (IN) is proactively issued to the endpoint of the USB device before the first host issues a request for isochronous transfer (IN) to the endpoint. Data from the USB device is sent to the first host when the first host issues the request for isochronous transfer (IN) to the endpoint.

In yet still another embodiment, during enumeration of a USB device before a first host, an NAK signal is sent as a response to a command from a second host for enumerating the USB device.

Embodiments in the present disclosure enable a USB device such as a USB keyboard or USB mouse to be available for two or more hosts. Moreover, by means of virtual switching, when the USB keyboard or USB mouse, having been enumerated, are switched among different hosts, no new enumeration is required. As a result, the USB keyboard or USB mouse are ready for use without performing a relatively time-consuming enumeration process. In addition, the USB keyboard and USB mouse are consistent with and have no difference from the physical USB keyboard and USB mouse. As a result, drivers provided by original manufacturers are still available for the USB KVM switch of the present disclosure.

Although the present invention and its advantages have been described in detail, it should be understood that various changes, substitutions and alterations can be made herein without departing from the spirit and scope of the invention as defined by the appended claims. For example, many of the operations discussed above can be implemented in different methodologies and replaced by other operations, or a combination thereof.

Moreover, the scope of the present application is not intended to be limited to the particular embodiments of the process, machine, methods and steps described in the specification. As persons having ordinary skill in the art will readily appreciate from the disclosure of the present invention, processes, machines, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, methods, or steps.

What is claimed is:

1. A universal serial bus (USB) keyboard-video-mouse (KVM) switch for connection between at least one USB host and at least one USB device, the USB KVM switch comprising:
a first virtual USB hub, configured to communicate with a first USB host;
a first virtual USB device, configured to connect to the first USB host via the first virtual USB hub, and configured with an endpoint setting data identical with that of a first USB device;
a microprocessor, configured to generate the first virtual USB hub and, in response to an event that the first USB device is electrically connected, enumerate the first USB device via a USB host control module and a USB hub; and
a first multi-address USB device control module, configured to be electrically connected to the first USB host and be seen by that USB host as the first virtual USB hub and, in response to an event that the first USB device is enumerated, determine the endpoint setting data of the first USB device.

2. The KVM switch of claim 1 further comprising:
a second virtual USB device, configured to connect to the first USB host via the first virtual USB hub, and configured with an endpoint setting data identical with that of a second USB device.

3. The KVM switch of claim 2, wherein:
the microprocessor is configured to, in response to an event that the second USB device is electrically connected, enumerate the second USB device; and
the first multi-address USB device control module is configured to, in response to an event that the second USB device is enumerated, determine the endpoint setting data of the second USB device.

4. The KVM switch of claim 1 further comprising:
a second virtual USB hub, configured to communicate with a second USB host,
wherein the microprocessor is configured to generate the second virtual USB hub.

5. The KVM switch of claim 4 further comprising:
another first virtual USB device, configured to connect to the second USB host via the second virtual USB hub, and configured with an endpoint setting data identical with that of the first USB device.

6. The KVM switch of claim 5, further comprising:
a second multi-address USB device control module, configured to connect to the second USB host and be seen by that USB host as the second virtual USB hub and, in response to an event that the second USB device is enumerated, determine the endpoint setting data of the second USB device.

7. The KVM switch of claim 6 further comprising:
another second virtual USB device, configured to connect to the second host via the second virtual USB hub, and configured with an endpoint setting data identical with that of the second USB device.

8. The KVM switch of claim 1, wherein the at least one USB device includes a USB keyboard, a USB mouse, and a USB audio device, a USB storage and a different class type USB peripheral device.

9. The KVM switch of claim 1 further comprising:
a video signal switching module, configured to connect to the video output of first host and provide an video signal to a display device.

10. The KVM switch of claim 1, wherein the endpoint setting data includes information on a polling interval for an endpoint in an interrupt transfer (IN), and the microprocessor is configured to, during an interrupt transfer (IN) period of the endpoint, issue a request for interrupt transfer (IN) to the endpoint of the first USB device before the first USB host issues a request for interrupt transfer (IN) to the endpoint.

11. The KVM switch of claim 1, wherein the endpoint setting data includes information on a polling interval for an endpoint in an interrupt transfer (OUT), and the microprocessor is configured to, during an interrupt transfer (OUT) of the endpoint, issue an ACK (acknowledgement) signal as a response when the first virtual USB device receives a request for interrupt transfer (OUT) issued from the first USB host to the endpoint.

12. The KVM switch of claim 1, wherein the endpoint setting data includes information on a polling interval for an endpoint in an isochronous transfer (OUT), and the microprocessor is configured to, during an isochronous transfer (OUT), synchronize the SOF of the first USB device with that of the first USB host.

13. The KVM switch of claim 1, wherein the endpoint setting data includes information on a polling interval for an endpoint in an isochronous transfer (IN), and the microprocessor is configured to, during an isochronous transfer (IN) of the endpoint, polls the first USB device for data from the endpoint in the isochronous transfer (IN) before the first host issues a request for isochronous transfer (IN) to the endpoint.

14. A method of switching universal serial bus (USB) devices among multiple USB hosts, the method comprising:
generating a first virtual USB hub and a second virtual USB hub corresponding to a first host and a second host, respectively;
enumerating a USB device and thereby obtaining the configuration descriptor of the USB device;
obtaining endpoint setting data of the USB device by analyzing and parsing the configuration descriptor of the USB device; and
based on the endpoint setting data of the USB device, generating a first virtual USB device corresponding to the first virtual USB hub and another first virtual USB device corresponding to the second virtual USB hub.
